(19) United States
(12) Patent Application Publication
(10) Pub. No.: US 2026/0080328 A1
(43) Pub. Date: Mar. 19, 2026

(54) SYSTEM AND METHOD FOR OPTIMIZING RULES USING A MACHINE LEARNING MODEL

(71) Applicant: NICE LTD., Ra'anana (IL)

(72) Inventors: Disha AGRAWAL, Pune (IN); Abhishek UNHALE, Pune (IN)

(73) Assignee: NICE LTD., Ra'anana (IL)

(21) Appl. No.: 18/887,506

(22) Filed: Sep. 17, 2024

(51) Int. Cl. G06Q 10/0631

(52) U.S. Cl. CPC G06Q 10/063116

(57) ABSTRACT

A system and method for intelligent computerized task scheduling and execution, including: optimizing a time off rule including a quota of time off units for a time period—by changing the quota of time off units based on calculating a time off utilization indicator; updating a computerized task schedule based on the optimized time off rule; and executing tasks based on the updated schedule. In some embodiments, time off optimization may include identifying, by a machine learning model (such as, e.g., a generative artificial intelligence or large language model), rules matching a given time off rule, and deleting/merging rules based on similar rule names or activity codes. The machine learning model may generate rule names for merged rules. Optimized time off rules may be used to accept or reject time off requests transmitted and/or received, e.g. over a data or communication network.

### FIELD OF THE INVENTION

The present invention relates generally to intelligent optimizations of rules, and more specifically to optimizations of time-off rules and quotas using machine learning techniques.

### BACKGROUND OF THE INVENTION

Time-off or downtime management may relate to breaks needed, e.g., for optimal or desirable utilization of resources (such as, e.g., time needed for cooling down or rebooting physical computer systems such as for example processing and/or storage units, in order not to overheat or overload these systems, which may result in deteriorated performance). Time-off management may relate to the planning, tracking, and administering absences or breaks, such as, e.g., employee vacations, sick leave, and other types of leave, to ensure both employee well-being and organizational efficiency.

Time-off management systems may address the complexities that arise from varying time-off rules across different systems, organizations and jurisdictions. Balancing resource health and needs with business continuity may become a challenging task—which, if not handled carefully, may lead to inefficiencies such as understaffing, overscheduling, compliance risks, and more. These challenges are exacerbated by diverse time-off policies relating to different rules or justifications for time-off, including, e.g., vacation, sick leave, and parental leave, each with its own accrual rates, carryover limits, and approval processes (similar issues may arise for non-human resources, which may, e.g., in the case of computer systems, have to be shut down or rebooted due to different, possibly contradicting considerations). There is a need for streamlining and optimizing time off management, for example, by automating time-off requests, approvals, and tracking time off use while ensuring compliance with various requirements and policies, which may ultimately enhance resource or workforce productivity and satisfaction.

### SUMMARY

A system and method for intelligent computerized task scheduling and execution may include, according to some embodiments: optimizing a time off rule—which may include a quota of time off units for a time period—by changing the quota of time off units based on calculating a time off utilization indicator; updating a computerized task schedule based on the optimized time off rule; and executing tasks based on the updated schedule.

In some embodiments, time off optimization may include identifying, by a machine learning model (such as, e.g., a generative artificial intelligence or large language model), rules matching or rules similar to a given time off rule, and deleting/merging rules based on similar rule names or activity codes.

In some embodiments, the machine learning model may generate rule names for merged rules. Optimized time off rules may be used for accepting or rejecting time off requests transmitted and/or received, e.g. over a data or communication network.

Some embodiments of the invention may be implemented on a cloud platform and using cloud based storage and/or processing components.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows example computer systems remotely connected by a data network according to some embodiments of the invention;

FIG. 3 shows a high level architecture diagram of an example system for managing time off rules according to some embodiments of the invention;

FIGS. 4A-B show an example implementation of a system for managing time off rules according to some embodiments of the invention;

FIG. 5 shows an example process for time off optimization and associated computations according to some embodiments of the invention;

FIG. 6 shows an example process for determining a utilization key performance indicator according to some embodiments of the invention;

FIG. 7 shows an example generation of an optimization plan according to some embodiments of the invention;

FIG. 8 shows an example time off rule automation and an example use of updated time off rules according to some embodiments of the invention;

FIG. 9 shows an example user interface (UI) according to some embodiments of the invention;

FIG. 10 shows some example data structures which may be used in some embodiments of the invention;

FIG. 11 shows an example time off rule optimization user interface (UI) and an example output by a generative artificial intelligence (GenAI) component according to some embodiments of the invention; and

FIG. 12 is a flowchart describing an example method for computerized task scheduling and execution according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Some embodiments of the invention may optimize quotas or amounts of time off or downtime units—based on information describing the utilization or use of these units, e.g., in real time. Time off quotas optimized by some embodiments may be associated with time off rules—where a given rule may specify a quota or amount of time off or downtime units for a corresponding resource pool, department, or organizational unit within a time period (for example, a time off rule such as, e.g., “hardware cooling” may specify a quota of 3 hours downtime units per period of a week where one or more computer systems in resource pool “parallel computing” may be shut down and/or rebooted). According to some embodiments, a quota of time-off units may refer to a predefined number of inactive periods, such as 3 hours of downtime, which may be allocated within a specific time frame or time period, such as for example a week, a month, and the like, during which no tasks may be scheduled and/or operations may be paused. Some embodiments may edit or merge rules using a machine learning model such as, e.g., a generative artificial intelligence (GenAI) or large language model (LLM) based on, e.g., utilization of time off units associated with the rules and based on rule names, identifiers, or activity codes. This may be desirable, e.g., in order to prevent accumulation of different time off rules in the system, which may be difficult to monitor, correlate, or manage. Some embodiments may update schedules and/or execute computer tasks based on optimized time off or downtime quotas and/or rules.

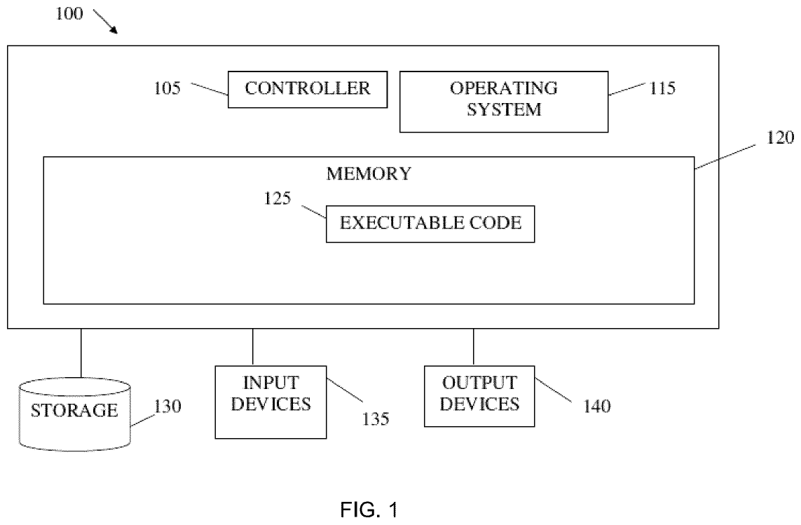

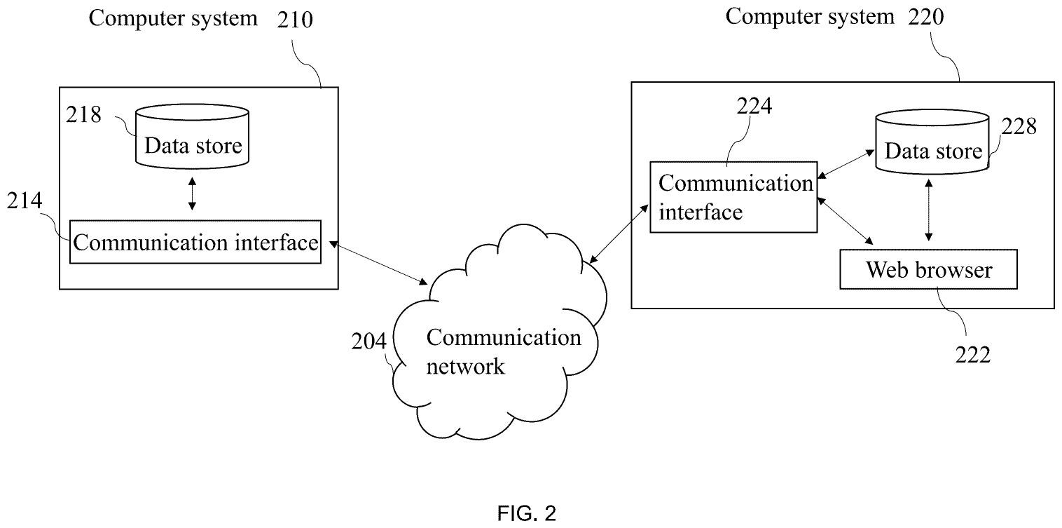

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

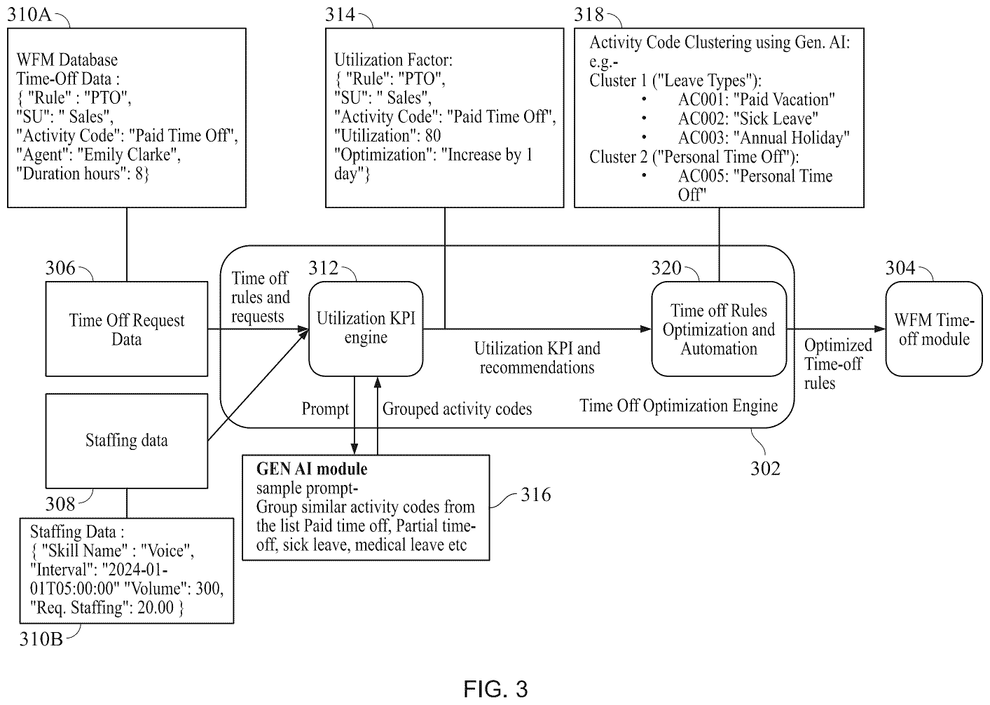

FIG. 2 shows example computer systems remotely connected by a data network according to some embodiments of the invention.

Some embodiments of the invention may include performing an exchange of data or data transfer between remotely connected computer devices. For example, remote computer 210 may send or transmit, over communication or data network 204, computerized data items, data elements, or data points of information (including, e.g., time off or downtime requests, GenAI or LLM prompts, rule update recommendations, and the like), to computerized system 220, and/or vice versa. Each of systems 210 and 220 may be or may include the various components described with reference to system 100, as well as other computer systems, and include and/or operate or perform, e.g., the various corresponding protocols and procedures described herein. In some embodiments, computerized systems 210 and 220 may additionally perform a plurality of operations including for example sending and/or transmitting and/or collecting and/or receiving additional data to or from additional remote computers systems. One skilled in the art may recognize that additional and/or alternative remote and/or computerized systems and/or network and connectivity types may be included in different embodiments of the invention.

In some embodiments of the invention, computer systems 210 and 220 may communicate via data or communication or data network 204 via appropriate communication interfaces 214 and 224, respectively—which may be for example NICs or network adapters as known in the art. Computerized systems 210 and/or 220 may include data stores such as, e.g., 218 and 228 which may for example include a plurality of received data items, messages, requests, reports, and the like, such as for example described herein.

As used herein, resource or workforce management (WFM) may refer to a process for optimizing the productivity, utilization and efficiency of a pool or set of resources, which may involve, for example, the following components or elements:
Staffing, which may encompass activities such as workforce planning and allocation to ensure that an appropriate number of resources or employees with the necessary skills are available to meet operational needs.
Scheduling, which may involve creating and managing work schedules and associated tasks to align with various constraints such as for example demand, resource or employee availability, and regulatory requirements, and, e.g., to maximize productivity while minimizing costs.
Time-off management, which may include tracking and managing resource allocation and breaks from performing work tasks which may, in some examples, include or refer to e.g. employee attendance, leaves, and overtime, which may be required for resource planning purposes and/or for ensuring compliance with labor laws, as well as for payroll related purposes.
Performance management, which may include setting or defining performance goals, conducting evaluations, providing feedback, and offering development opportunities to enhance resource or employee performance and/or job satisfaction.
   Overall, effective resource or workforce management may ensure that the right resources are used at the right time, to perform a desirable task to a desirable extent (such as, e.g., according to predefined quotas and/or amounts and/or units or periods of time, such as for example a quota of 28 days in a 30 day time period where a CPU may be continuously used for processing jobs or calculations)—e.g., to contribute to performance goals or targets such as for example organizational success. It may require a strategic approach that balances operational needs and goals with knowledge and consideration of factors relating to resource utilization, such as for example resource capacities, employee well-being and development, and the like.

As used herein, time-off management may refer to the process of managing and tracking requests for and use of a “time off” or downtime—which may refer to or may be a time period where a given resource may be inactive, unavailable, or may cease to perform tasks. According to some embodiments, time off or downtime may include, e.g., vacation days, sick leave, personal days, and other types of authorized absences from work or controlled pauses or breaks from performing tasks. Additional examples unrelated to human resources are provided herein.

According to some embodiments, key aspects of time-off management may include, for example:
Time-off rules, which may be a set of rules or policies that may define or outline how time off or downtime may be initiated, requested, or used. The rules may relate to or define, for example, how employees may request time off, how long of a notice is required for a request to be processed, time off or downtime quotas or amounts per resource and parameters such as, e.g., maximum accruals, blackout periods (which may be, e.g., time periods when time off requests may be restricted or automatically denied). As demonstrated herein, in some embodiments, time off or downtime rules may be computerized data structures or entries in a computerized database.
Request and approval process: requests or commands for time off or downtime may be submitted through dedicated application or user interfaces (such as for example workforce management (WFM) applications, see some nonlimiting examples herein). Such requests may be reviewed or considered based on, or in light of, operational needs, staffing levels, and existing policies or rules before determining to approve or deny a given request. Also, a summary describing, e.g., time off considerations (such as for example resource capacity, quotas or amounts of time off requests to be allowed, and the like) may be maintained or stored, e.g., in a dedicated database, and may be displayed to a manager/administrator/agent (for example via a user interface (UI)) at the time of a request may be made, or may be considered to be approved or denied. As demonstrated herein, a request may be, in some embodiments, a computerized data structure or item sent, transmitted or triggered as part of a computerized data transfer over a data/communication network.

Effective time-off management may not only support, e.g., agents' work-life balance but may also help systems and organizations maintain productivity, manage staffing levels effectively, and ensure compliance with legal and regulatory requirements.

According to some embodiments, a time off rule may include a quota of time off units for a time period. A time off or downtime unit may be a standardized measurement of inactivity, e.g., in standard units of time, such as for example a minute/hour/day, which may be used to quantify periods when normal operations may be paused or when resources may be idle or not working. A time-off rule as used herein may refer to a policy being or including a plurality of conditions and criteria that determining whether a break or period of absence may be allowed (or not allowed), including, for example, criteria for eligibility, duration limits, and approval/rejection processes. In some embodiments of the invention, a time off or downtime rule may be a computerized data structure and/or correspond to entries in a computerized database of time off rules. In some embodiments, and, e.g., as further demonstrated herein, a time off rule may specify or may be associated with a scheduling unit (which may be or may refer to a resource pool, department, or resource unit to which a given resource belongs, such as “sales” or “parallel computation”), may include a quota, amount or number of time off or downtime units which may be used or utilized for a given time period (such as, e.g., 30 time off units of paid time off days per time period of a year), and may include or be associated with an identifier such as, e.g., a rule name and/or an activity code (such as for example “paid time off”, “hardware cooling”, “maternity leave”, and the like). Additional or alternative parameters may be included in time off rules according to different embodiments.

Some embodiments may optimize time off quotas and/or merge time off rules, e.g., according to some of the computerized procedures described herein.

Some technology systems for time off management may have several shortcomings. In some systems, managers may be required to manually create time-off rules for, e.g., out-of-office days without knowing the utilization of quotas or amounts of time off units, or time off units already used as part of different, existing rules—and by relying instead only on pre-known compliance guidelines. This may result in outdated or unused rules and/or activity codes accumulating in the system (and, e.g., accruing time off units and not being removed or deleted), and may cause imbalances in allocated time-off days for activity codes and/or rules. Managing or keeping track of numerous rules (having or being associated with, e.g., different rule names or activity codes) may become an administrative burden for managers and may impact agent experience and/or effective resource utilization. Additionally, the maximum allowable time-off requests (which may refer to a quota of time off requests that may be allowed in a given time period, such as for example 4 requests that may approved per 1 month, and may be included in a time off rule similarly to quotas or amounts of time off units) may be required to be calculated manually after staffing generation, which may risk creating unexpected staffing shortages or surpluses if requests are not managed effectively.

Some embodiments may provide a structured approach to optimize time-off rules based on utilization scores or key performance indicators (KPIs) and automate their management. Initially, the utilization KPI, which may signify, in some embodiments, the average number of time-off units/days taken by agents or resources, may be calculated or determined for each rule using historical time-off related data spanning a specified time period (which may be e.g., 1 year). For existing rules, actions may then be determined or decided based on this KPI. For example, rules showing high utilization values, e.g., above a specified threshold, may undergo automation to change or increase a quota of allocated time-off days while ensuring compliance to various policies and/or legal regulations, and rules with low utilization values, e.g., below a specified threshold, may be automatically deleted or removed, e.g., in order to streamline allocation. In some embodiments, rules with utilization below the threshold may be automatically combined where applicable, and an appropriate quota of time-off units (such as, e.g., a number of days) may be recommended by some embodiments.

In some embodiments, grouping and/or combining of rules may be facilitated by analyzing activity code names or identifiers using generative artificial intelligence (GenAI) technology, which may allow for optimizing efficiency in rule management. Finally, the maximal number of time off or downtime requests that may be submitted and/or approved for a given period (also referred herein as the “maximum allowed time-off requests”) may be determined, for example, by analyzing and accounting for staffing patterns or requirements, which may enable ensuring that approved time-off requests align with operational needs, e.g., without compromising service levels. Some embodiments of the invention may aim to enhance operational efficiency, improve compliance, and streamline the management of time-off rules within the organization.

A “task” as used herein may be or may refer to a computer task or operation. For example, in some embodiments of the invention, a task may be, e.g., a computation or processing operation, e.g., by a computer processor—which may involve for example generating outputs, writing to and reading from computer memory, and the like. Schedules altered or updated by some embodiments may include a plurality of tasks or operations, e.g., to be performed or executed by or using a computer system or a plurality of systems. In this context, a schedule of tasks (e.g., for a resource such as, e.g., a computer system) according to some embodiments may be a predefined sequence of operations that the resource or system may execute at specified times or intervals. In this context, time-off units may represent designated periods during which no tasks are scheduled, allowing the system or resource to pause, power down, and the like. A nonlimiting example schedule may have the form of: {[08:00-09:00: Data backup]; [09:00-10:30: System update]; [10:30-11:00: **Downtime** (No tasks scheduled)]; [11:00-12:00: Security scan]; [12:00-13:00: **Downtime** (No tasks scheduled)]; [13:00-14:00: File compression]; [14:00-15:00: Database maintenance]; [15:00-16:00: **Downtime** (No tasks scheduled)] . . . additional or alternative schedule formats may be used in different embodiments. In some embodiments of the invention, tasks may be or may include computer operations executed by a human user or agents. For example, in some nonlimiting embodiments, a contact or call center agent may handle tasks, computer operations, or interactions such as, e.g., handling voice over internet protocol (VoIP) calls or instant messaging chats using a computer system or device (such as, e.g., system 100) being a device among a plurality of interconnected devices to which interactions may be routed (e.g., using an automatic call distributor) over a data or communication network.

It should be noted that while some example embodiments are described herein with regard to the nonlimiting use case of a contact center, other embodiments may be used in contexts not limited to a contact center environment or to an environment including human users. For instance, some embodiments may be used for optimizing time off and/or rules relating to the use of computerized resources such as, e.g., CPU/GPU cores, memory/storage units, and the like—which may include setting a time off, downtime, or cooling periods for physical computer resources to avoid overheating (and related damage to the resources). In addition, some embodiments may be used to optimize rules including quotas, amounts, or units that may not be related to time off and/or scheduling, but to the utilization of quotas in a given rule or a set of rules. For instance, some embodiments may be used for optimizing rules and changing time off unit quotas relating to utilization of a set of computer resources such as, e.g., for a rule R1 having a name or activity code of “neural network matrix transform” and specifying a quota Q1 of CPU cores, and rule R2 having a name or activity code of “matrix algebra in deep layers” and specifying a quota Q1 of CPU cores, some embodiments may merge R1 and R2 into a single rule having a quota of, e.g., Q1, and may automatically generate a name or activity code such as, e.g., “neural network matrix algebra” for the new rule—for example using a machine learning model and/or based on various operations described herein.

FIG. 3 shows a high level architecture diagram of an example system for managing time off rules according to some embodiments of the invention.

A time off optimization engine 302 may integrate and/or process information from various data sources to optimize time-off rules and may, for example, be included in, embedded within, or integrated with a resource or workforce management (WFM) system, program, or application (such as for example the Nice CXOne, IEX workforce management suite, and employee engagement manager (EEM) programs), for example using an appropriate WFM time off module 304 (and for example using appropriate application programming interfaces or APIs). An example time off or downtime management process may begin with two inputs such as, e.g.: time off request data 306 and staffing data 308 which may be present in or may be fetched from dedicated databases such as, e.g., databases 310A-B. In some embodiments, a database such as, e.g., database 310A may include information on a given time off rule or request, or on a plurality of past rules or requests, such as the type of leave (e.g., paid time off (PTO)), employee's department or scheduling unit (e.g., “Sales”), activity code (e.g., “Paid Time Off”), the agent's name (e.g., “Emily Clarke”), and the duration or length of the leave (e.g., 8 hours). See also example data structure provided herein that may be stored or documented in the database.

Inputs 306-308 may be fed into utilization KPI engine 312, which may calculate scores or key performance indicators (KPIs) describing or related to time off or downtime utilization. The output may be in the form of a utilization KPI, score, value or factor 314 which may be stored with, may include, or may be associated with details, information or metadata such as, e.g., the type of leave, the scheduling unit, the activity code, the current utilization rate (e.g., 80%) for a given rule, and optimization recommendations (e.g., “Increase by 1 day”). Based on staffing data for each rule, some embodiments may compute or determine a maximum allowed requests value for a given rule.

Some embodiments may include identifying, by a machine learning model, one or more rules matching the time off rule, the identifying based on activity codes for the rules similar to the time off rule. In some embodiments, the identifying of the one or more rules matching the time off rule comprises clustering, by the machine learning model, one or more of the rules into one or more clusters, wherein the one or more rules matching the time off rule are included in one of the clusters including the time off rule.

In some embodiments, engine 302 may include or may use a machine learning model such as for example an GenAI or LLM module or component 316 for identifying matching time off rules, which may include name or activity code grouping or clustering, or grouping similar or matching names or activity codes into groups or clusters 318. According to some embodiments, similarity between terms, names or activity codes may refers to a measure of how closely related or semantically equivalent two words, phrases, terms, names or codes are, as may be quantified, e.g., by comparing their vector representations in a high-dimensional space using a corresponding similarity or distance formula (such as for example the cosine similarity formula provided herein). According to some embodiments of the invention, a rule A may be determined as similar to a rule B, if a comparison between the vector representation or embedding for the activity code or name of rule A and the corresponding representation or embedding for the activity code or name of rule B results in a similarity value higher than a predetermined threshold (for example: if a similarity value calculated for the activity codes of rules A and B is above a threshold value of 0.8—some embodiments may determine that the two activity codes, and that rules A and B are similar). As nonlimiting examples, a first group or cluster (“Leave Types”) may include, may be based on, or may be associated with “Medical Emergency”, “Sick Leave”, and “Compassionate Holiday”, and a second group or cluster (“Partial Time Off”) may include codes like “Partial Time Off”, “Half day” etc. Some embodiments may cluster or group activity codes for rules satisfying conditions or criteria, such as for example having a utilization KPI or score values below a predetermined threshold. In some embodiments, a machine learning model such as for example a GenAI or LLM model may identify rules matching a given time off rule based on clustering and semantic analysis: for instance, an LLM may be trained using a comprehensive corpus of documents to identify or determine that two terms or activity codes such as “Medical Emergency” and “Sick Leave” may be related, similar, or matching (and may therefore be included in a first cluster), and that terms or codes such as “Partial Time Off” and “Half day” may be related, similar or matching (and, e.g., be included in a second cluster different from the first cluster)—for example based on or using vector embeddings or representations for relevant terms or tokens, and/or based on similarity or distance scores or metrics for terms or tokens (which may be or may include identifiers or activity codes) using an appropriate similarity or distance formula such as for example the cosine similarity formula, such as, e.g., (A·B)/(∥A∥×∥B∥)=(Σ(A_i×B_i))/(√Σ(A_i²)×√Σ(B_i²)), where A and B are different vector representations or embeddings for, e.g., two different terms, identifiers, or codes and where i may designate a given entry of a plurality of entries in a given vector or embedding. Additional or alternative similarity formulas or calculation procedures may be used in different embodiments.

In some embodiments, identifying similar activity codes or time off rule names (e.g., as part of identifying rules matching a given time off rule) may be performed by the GenAI or LLM, and for example using an appropriate example LLM prompt such as, e.g., “Identify the similarity between the following activity code “Medical Emergency” and “Sick Leave” using a cosine similarity metric/algorithm”, or “cluster the following activity codes: “Medical Emergency”, “Sick Leave”, and “Half Day” into topic clusters using a cosine similarity metric/algorithm”. Additional or alternative example prompts may include additional content such as for example information explaining or elaborating on the meaning of each activity code input to the GenAI or LLM. An example output of an example similarity or distance calculation (e.g., using the cosine similarity formula or a different formula) for a pair of names or codes X and Y may be a number ranging from −1 (most dissimilar) to 1 (most similar or identical). If a calculated similarity value or result is above a predefined threshold T, such as e.g. T=0.8, rules X and Y may be merged or unified as a single rule (see further examples herein), or not merged if the calculated similarity value is below T. Clustering and merging of a plurality of rules may be done, for example, using pairwise similarity calculations: some embodiments may calculate similarity score between each pair of activity codes for each pair of rules, e.g., using the cosine similarity formula, and group the codes into clusters by applying a clustering algorithm, such as hierarchical clustering or k-means clustering, which may group or cluster codes that may be more similar to each other into the same cluster, thereby organizing the activity codes into meaningful categories based on their similarity. Accordingly, some embodiments may identify N rules matching a given time off rule R, e.g., if the N rules are clustered or grouped into a single cluster together with rule R. Otherwise, if the N rules were not clustered or grouped together with R, or are not included in a cluster including R—some embodiments may determine that the N rules are not matching R.

Example machine learning models such as for example GenAI or LLM components or modules that may be used in some embodiments may include, e.g., Generative Pre-trained Transformer (GPT) or Bidirectional Encoder Representations from Transformers (BERT) models or services, which may be, e.g., constructed using a transformer architecture and trained in two phases: pre-training on large, comprehensive text corpora to predict the next word in a sentence, and fine-tuning on specific tasks (such as, e.g., clustering names or activity codes) to improve performance in those areas (which may be performed, for example using reinforcement learning techniques and a labeled dataset including, for example, similarity values for a plurality of names or codes as provided, e.g., by a subject matter expert or system administrator). Additional or alternative models, architectures, or LLM services (which may be incorporated into some embodiments, e.g., using appropriate APIs) may be used in different embodiments.

The clusters or grouped activity codes and utilization factors or KPIs 314, along with recommendations, may be sent to time off rules optimization and automation module 320, which may optimize the time-off rules and forward them to a WFM time-off module or UI 304, which may enable or provide optimization options or recommendations to be used by, e.g., managers and/or system administrators.

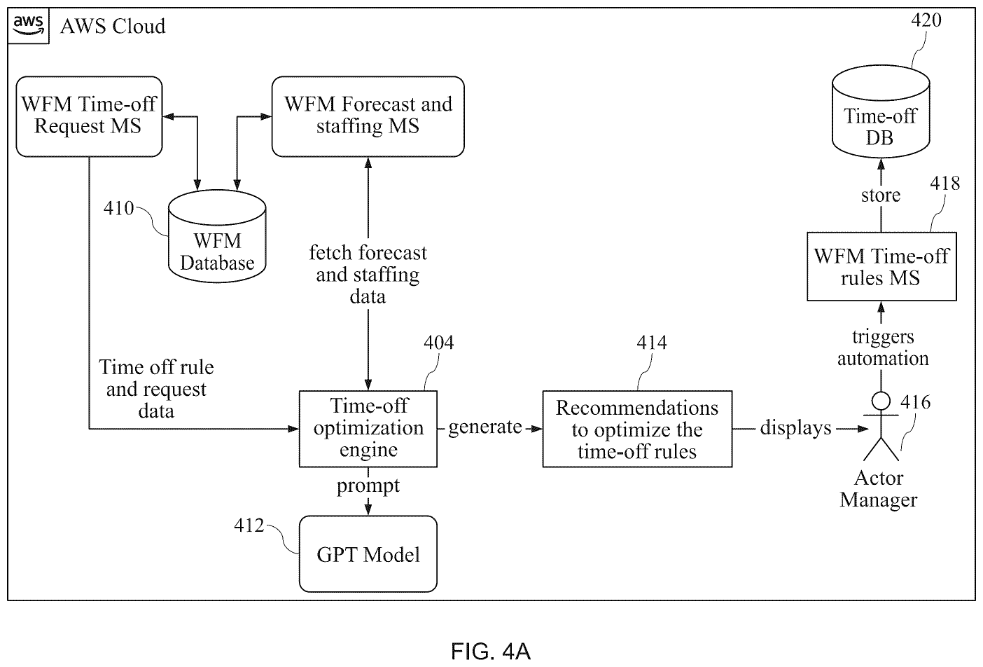

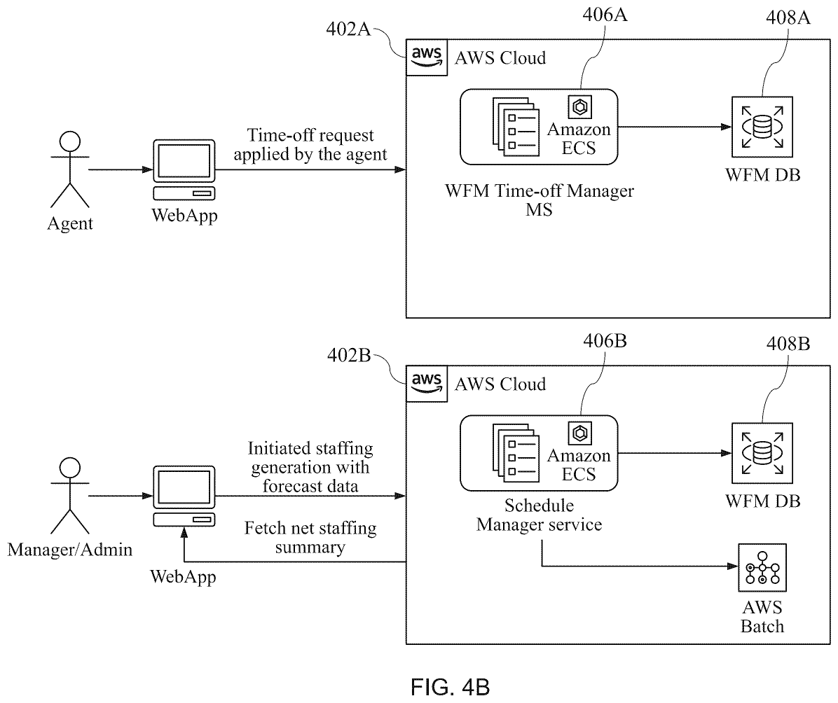

FIGS. 4A-B show an example implementation of a system for managing time off rules according to some embodiments of the invention.

In some embodiments the optimizing of the time off rule and the updating of the schedule are performed using a cloud platform, and wherein the optimizing of the time off rule comprises fetching staffing data from a cloud-based database.

In some embodiments, a plurality of components may be deployed on a cloud platform such as, e.g., the Amazon web services (AWS) private network 402A-B with appropriate (e.g., restricted) access rules. Time-off optimization engine 404 may depend on input data received or fetched from different cloud based microservices, application programming interfaces (APIs; e.g., of WFM systems or applications) and components which may be deployed using the AWS elastic container service (ECS) containers 406A-B and using the AWS relational database service (RDS) 408A-B for data storage.

According to some embodiments, engine 404 may incorporate various components to analyze input data. This may be illustrated or exemplified through a nonlimiting use case or scenario such as, e.g., the presented in Table 1:

```
TABLE 1
Use case: a manager/Admin decides to optimize the time-off rules
Initiation: a manager may trigger the optimization process, e.g., by clicking on a dedicated
button to optimize time-off rules (see, e.g., some nonlimiting examples herein).
Data retrieval: upon initiation, the time-off optimization engine may fetch relevant time-
off request and staffing data (e.g., from WFM database 410, see also example data
structures provided herein) as input for calculation.
Time-off optimization calculations: upon data retrieval, engine 404 may compute the
following:
  1. Utilization KPI or score - which may indicate the percentage of time-off utilized
  or used for each rule, such as, e.g., described in some nonlimiting examples herein.
  2. “Maximum allowed request” - which may be a value or amount used to balance
  the staffing and the “maximum allowed time-off” (or quotas of time off), e.g., by
  limiting the number requests that may be submitted for a given time off or
  downtime rule (for example by specifying a limit or amount of requests that may
  be allowed to be submitted for a given time period or interval, and beyond which
  submitted requests may be automatically rejected, such as for example
  demonstrated herein).
Along with KPI computation, the engine or module may generate prompts for clustering
of the rules and receive or process additional outputs and carry out further steps.
GenAI or LLM module 412: this machine learning component or module may receive or
take an input of list of activity code, identifiers, or names which may be required for
clustering. Based on the similarity in the names a grouping of rules may be recommended
and/or performed.
Recommendations 414: following optimization, the GenAI or LLM module or component
and/or the time off optimization engine may be used to generate optimization
recommendations for the time-off rules. Depending on the KPI values and GenAI
recommendation, allocated or allowed time off may be increased for certain rules, and
some rules may be grouped together. For example, the time off optimization engine may
perform automated actions such as for example merging time off or downtime rules that:
(A) were clustered together or were found similar by the GenAI or LLM, and (B) for which
utilization KPI values below a predetermined threshold T (e.g., where T=0.3 or 30%) were
calculated. In another nonlimiting example, the time off optimization engine may perform
an automated action of increasing the quota or amount of time off units for a given rule,
e.g., if a utilization KPI value above a predetermined threshold T (e.g., where T=0.9 or
90%) was calculated for that rule. See also nonlimiting example herein showing a
calculation of an amount of units (or recommended number of units) which may be
automatically added to the quota (or be used in an automated increase or change of a time
off quota) according to some embodiments of the invention. Additional or alternative
automated actions, based on additional or alternative logic, conditions, or criteria may be
used in different embodiments.
Automation: generated recommendations may be shown or presented to the manager 416
(e.g., using a graphical user interface). Based on the manager's input or approval, an
automation of the recommendations/rules to a relevant WFM system may be performed or
triggered, e.g., using a WFM time off rules microservice 418. According to the
recommendation allocated days for certain rules may be increased and certain unwanted
rules may be deleted from the system. The new, updated rules may be displayed to the
manager via a user interface, e.g., of the WFM webapp, and/or saved or stored in a database
(such as, e.g., dedicated time off database 420).
```

Some embodiments may include optimizing a time off rule, the rule comprising a quota of time off units for a time period, wherein the optimizing comprises changing the quota of time off units based on calculating a time off utilization indicator, the calculating of a utilization indicator based on a utilized time off value and the quota of time off units. In some embodiments, the optimizing of the time off rule and the updating of the schedule are performed based on a staffing requirement, the requirement comprising a number of resources needed for the time period.
Some example data structures and/or formats, as well as additional details regarding some relevant components which may be used as part of the example implementation described in FIG. 4A-B are provided in Table 2.

```
TABLE 2
Time off request data may be a data structure representing a time-off request. Several such
request may be present or may be used in a cloud based WFM database (which may be an
AWS RDS database). Such a request may belong to a respective tenant or unit (such as a
“sales department”, may be stored in a corresponding database, e.g., for a predetermined
time period (e.g., of 1 year), and may be fetched and/or treated as historical data. A data
structure used for describing or representing a time off request may be, e.g., a text or JSON
file such as for example:
  { ″Rule name“ : “PTO″,
  “SU″: ″ Sales“,
  “Activity Code″: “Paid Time Off”,
  “Agent″: “Emily Clarke”,
  “Duration/hours”: 8 }
where “rule name” may be a name or title of the time off rule associated with the request
and/or the agent requesting time off, a specific organizational or scheduling unit (SU) may
be, e.g., the department the agent may be associated with (e.g., “sales”), an “activity code”
may be an identifier or name associated with the time of rule which may, e.g., be used as
an input to an LLM or GPT model such as, e.g., described herein, an “agent” field may be
a name or identifier of the agent requesting time off, and “duration/hours” may specify an
amount of time units (e.g., hours) for which time off may be requested.
Staffing data may be a data structure representing interval wise staffing requirements, or
staffing requirements for a given time interval. For example, for each of a plurality of 15
minute intervals, a required number of resources or agents and some additional data such
as KPIs or KPI values such as, e.g., average handling time (AHT) of a task, operations, or
interaction, may be included in staffing data. Historical staffing data (such as, e.g., staffing
data generated or used for a given year and specifying a number of resources needed or
used per period) may also be retrieved or fetched, e.g., from cloud storage based WFM
database 410. An example data structure for staffing data may be, e.g., a text or JSON file
such as for example:
  { ″Skill Name“ : ″Voice″,
  “Interval″: ″2024-01-01T05:00:00“ ″Volume″: 300,
  “Req. Staffing (or number of resources needed/used)″: 20.00}
where “skill name” may describe a skill, topic, or task or operation type a given agent or
resource may be associated with (such as, e.g., “voice calls”, “CPU intensive computation”,
“graphical processing unit (GPU) computation”, and the like), “interval” may describe or
specify the time interval (e.g., a specific time period, in a specific hour, day, year, and the
like), and “req. staffing” may be a staffing requirement such as, e.g., 20 agents or resources
may be needed for the skill “voice” in the specified time interval. Some embodiments may
calculate scores or metrics based on staffing data spanning a predetermined time interval
or time period, such as for example staffing data for 1 year (including, e.g., all time
intervals and corresponding staffing data or information included in that year).
Time-off optimization engine: time off requests, time off rules and staffing data may be
provided to a time off optimization engine (such as, e.g., elements 302, and/or 404). In
some embodiments, the engine may be, e.g., a component written or programmed in the
Java programming language, which may be integrated with the GenAI module and execute
operations and algorithm such as, e.g., described herein. It may include a plurality of sub
modules such as, e.g.:
```

| | |
|---|---|
| 1. | Utilization KPI engine: this may be a subcomponent or submodule for fetching |
| | or receiving time off requests, time off rules and staffing data as input and may |
| | calculate a utilization KPI or utilization score for each rule or for a given rule. |
| | It may also calculate maximum allowed time-off requests for each time off rule |
| | or for a given rule. Both KPIs or values may be calculated such as, e.g., further |
| | described herein. An output produced or generated by this component may be, |
| | e.g., a text or JSON file such as for example: |
| | {″Rule“ : “PTO″, |
| | “SU″: ″ Sales“, |
| | “Activity Code″: “Paid Time Off”, |
| | “Utilization”: 80 |
| | “Optimization”: ”Increase by 1 day”} |
| | where “rule”, “SU” and “activity code” may be similar to the fields described, |
| | e.g., with reference to a time off request data structure, where “utilization” may |
| | be the calculated or computed utilization KPI or score value, and where |
| | “optimization” may be or may include a recommendation to change or update |
| | time off rules and corresponding quotas of time off units based on the calculated |
| | utilization KPI value, which may, e.g., be provided by an LLM or GPT module. |
| 2. | Integration with GenAI module: this subcomponent may generate and provide |
| | a prompt to the GenAI module and may receive a corresponding |
| | recommendation or response for grouping of activity codes. The GenAI module |
| | may for example be a dedicated, trained model or LLM, or an existing model |
| | such as, e.g., a generative pre-trained transformer (GPT) model or component |
| | which can be used, e.g., for grouping similar codes together. |
| 3. | Time off rules optimization and automation: this subcomponent may receive or |
| | take recommendations, responses or outputs from GenAI module or |
| | component, and/or from the utilization engine, and may perform the |
| | optimizations of time off rules based on the relevant recommendations, |
| | responses, suggestions, or outputs. |

A WFM time-off module may show or present optimized time off or downtime rules, e.g.,
on a time off user interface, screen, or output device.

Additional or alternative modules and/or data item or file formats or forms may be used in different embodiments.

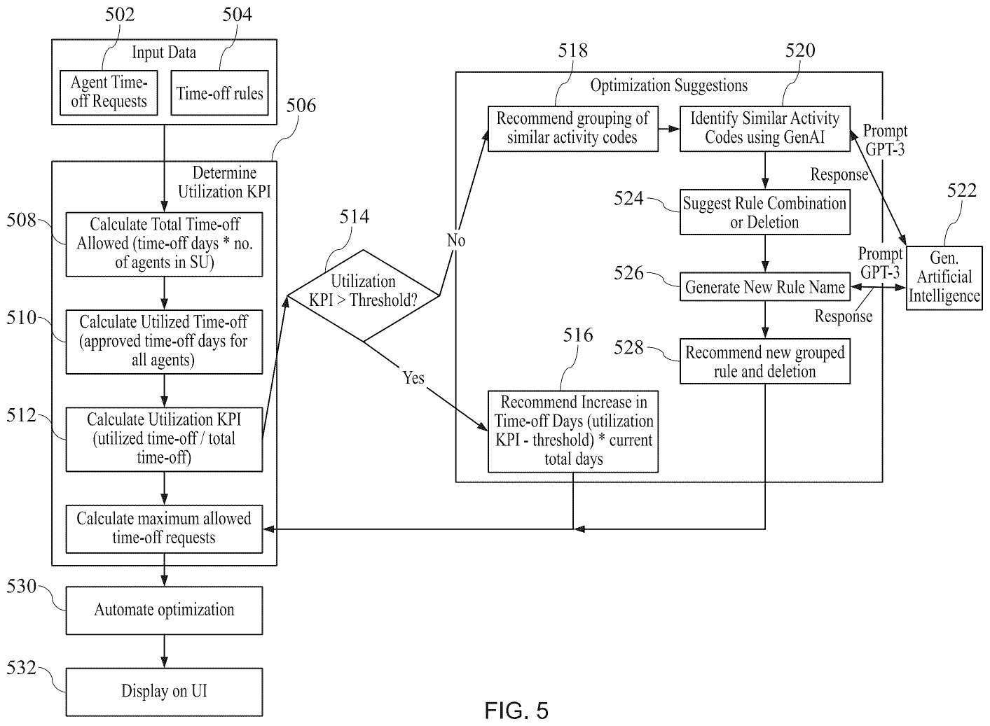

FIG. 5 shows an example process for time off optimization and associated computations according to some embodiments of the invention.

An example process for optimizing time-off requests and rules using utilization scores or KPIs and artificial intelligence according to some embodiment of the invention may begin with two types of input data: agent time-off requests 502 and time-off rules 504 (which may be existing rules stored or kept in a corresponding WFM platform or database).

Some embodiments may include optimizing a time off rule, the rule comprising a quota of time off units for a time period, wherein the optimizing comprises changing the quota of time off units based on calculating a time off utilization indicator, the calculating of a utilization indicator based on a utilized time off value and the quota of time off units. A time off utilization indicator according to some embodiments may describe how many time off units among a quota or predefined number of time off or downtime units allocated or “allowed” for a given time period (e.g., a week) were used or were approved to be used. Time off utilization indicators may be used to assess or determine whether the number or quota of time off units in a time off rule may be changed (e.g., more time off units should be added), and/or if time off rules may be merged or unified (e.g., if the rules are under utilized, or if time off units associated with the rules are not used to a desirable extent—e.g., according to a predetermined threshold value) Some embodiments may determine or compute a utilization KPI 506, for example, by performing several calculations:
Calculate total time-off allowed (TTO) 508: this may be or may represent the total quota of time off or downtime units included in or associated with the relevant time off rule. According to some embodiments, a TTO value may be determined, e.g., by multiplying a number or quota Q of time-off units (e.g., days) allocated for a single agent per unit of time or time period (e.g., per month) by the number of agents N in the specific organizational unit (SU), according to, e.g. TTO=Q*N. In one nonlimiting example, each agent may have a quota of 4 days per month, and an SU may include 5 agents. Accordingly the total time off allowed value may be calculated as, e.g., TTO=4*5=20 total time off days per month (units for TTO may accordingly be n time units per time period t or n/t: specific nonlimiting cases may include, e.g., hours/day, days/month, and the like).
Calculate utilized time-off (UTO) value or utilized downtime value 510: this may represent the total approved or used time-off days for all agents in the organizational unit. For example, a manager may have already approved, or agents may have already used or utilized 5 time off units or days for a given month (e.g., the current or present month) and accordingly UTO=5 (A UTO value may therefore be unitless and may quantify a number of units: specific nonlimiting examples: 2 hours, 3 days, etc.).
Calculate utilization KPI 512: this may be calculated, e.g., as a percentage of the UTO among the TTO, for example by dividing the utilized time-off by the total time-off allowed. For example, considering the above nonlimiting examples, a utilization KPI may be calculated given a nonlimiting example of a UTO value of 5 days and a TTO value of 20 days per month as, e.g., utilization KPI=UTO/TTO=5/20=0.25 or 25%.
The next step may be assessing or determining whether the computed or calculated utilization KPI exceeds a predefined threshold 514. If the KPI exceeds the threshold, the system may recommend a change such as, e.g., an increase in time-off units or days 516. The recommendation or recommended increase or the change in time off units or days may be determined or calculated, e.g., by multiplying the difference between the utilization KPI and the threshold by the current total days or current quota of time off units, and/or by UTO or the number of already utilized time off or downtime units, e.g., according to the example formula Time_off_unit_change=(uKPI−T)*UTO, where uKPI is the utilization KPI calculated for a given rule, UTO is the calculated utilized time off value for the rule, and T is a predetermined threshold. For example, a predefined threshold T may be 0.5, and, e.g., for a utilization KPI (uKPI) value of 0.75 or 75%, and given that 4 time off days have already been utilized by agents, some embodiments may calculate a recommended change or increase in time off units as: recommended increase=(uKPI−T)*UTO=(0.75−0.5)*4=1, or 1 day. In some embodiments, the calculated change or increase may be automated or executed to change the quota of time off or downtime units associated or included in a given time off rule.

Some embodiments may include identifying, by a machine learning model, one or more rules matching the time off rule, the identifying based on activity codes for the rules similar to the time off rule. Some embodiments may include performing one or more of: deleting one or more of the identified rules, and merging the time off rule with one or more of the identified rules.

If the utilization KPI does not exceed the threshold, the system may suggest grouping similar activity codes 518, e.g., using an LLM or machine learning model. This may involve, for example, several sub-steps:
Identifying matching rules, or rules matching a given time off rule, based on similar activity codes 520: a machine learning or LLM such as, e.g., a GenAI model 522 (such as, e.g., GPT-4o or alternative example models or GenAI components) may be used or utilized to find and suggest similar activity codes, or identify rules for which activity codes may be determined similar (as may be quantified, e.g., by comparing vector representations or embeddings using a similarity or distance formula and based on a predetermined threshold such as, e.g., if an embedding for an activity code or name for rule A and an embedding for an activity code/name for rule B, when plugged into a similarity formula—such as, e.g., the coside similarity formula—result in a similarity or distance value above a predetermined threshold of 0.8, then rules A and B may be determined or deemed similar; otherwise they may be determined dissimilar)
Suggesting rule combination or deletion 524: based on the identified similar codes or codes identified as similar, some embodiments may propose combinations or deletions of existing rules.
Generating new rule name 526: the LLM or GenAI model may be used in creating a new rule name for a rule (such as for example an updated or newly created time off rule merging a plurality of underutilized rules) including the grouped codes.

Recommending new grouped rule and deletion 528: final recommendations and/or automated actions performed by some embodiments may include merging or unifying rules identified as matching, or rules matching a given time off rule (for example in a case where for each rule in a set or group of matching rules a utilization KPI value below a predetermined threshold, such as, e.g., 0.7, was calculated), which may include, e.g., creating a new rule combining or merging the identified rules corresponding to grouped activity codes and including a changed or updated quota of time off units with reference to the merged rules—and/or deleting some identified rules (which may include, e.g., removing or deleting rules from the relevant time off database) such as for example deleting rules determined as obsolete (According to some embodiments, rules may be identified as obsolete based on, e.g., their creation date and/or low utilization below a predefined threshold T. For instance, a rule X may be considered obsolete, and may be removed or deleted by some embodiments if a utilization KPI value below T=0.2 or 20% was calculated for it, and if its corresponding rule data structure was created more than 3 months prior to the utilization KPI calculation date; otherwise the rule may be kept in the system and/or unified or merged with other rules). In some embodiments, as part of merging rules X and Y, a new rule data structure Z (for a rule “A+B”) may be created to include a quota of time units which may be, e.g., a combination or sum of the quotas of merged rules A and B, and an LLM or GenAI created or generated rule name or code (see nonlimiting examples herein). Following the merging or unifying of rules A and B, some embodiments may delete the original rule data structures for merged rules A and B, and the time off optimization engine may calculate a utilization KPI for the unified or merged rule A+B, which may include or may be performed using the combined quotas and utilization values of the rules merged or unified: for example if rule A includes a quota of 10 days or rule B includes a quota of 5 days, the time off unit quota for the merged rule A+B may be, e.g. 10+5=15 days; if 3 days were utilized for rule A, and 2 days were utilized for rule B, then the utilized days or units for the combined rule A+B may be, e.g., 3+2=5 utilized days. Accordingly, some embodiments may calculate or compute (e.g., using the time off optimization engine) utilization KPI values for a newly created, unified or merged rule, and may for example change the quota of time off units based on calculated utilization KPI values such as, e.g., demonstrated herein. See, e.g., nonlimiting examples provided herein and describing merging rules and changing or increasing a quota of time off units for a given rule. Additional or alternative rule merging procedures may be used in different embodiments.

These optimization suggestions or recommendations may then be used to automate the optimization process 530, and optimization suggestions and/or results may be displayed on a user interface (UI) 532. The integration or use of AI in some embodiments may ensure continuous improvement and streamlining of time-off management rules and their optimization.

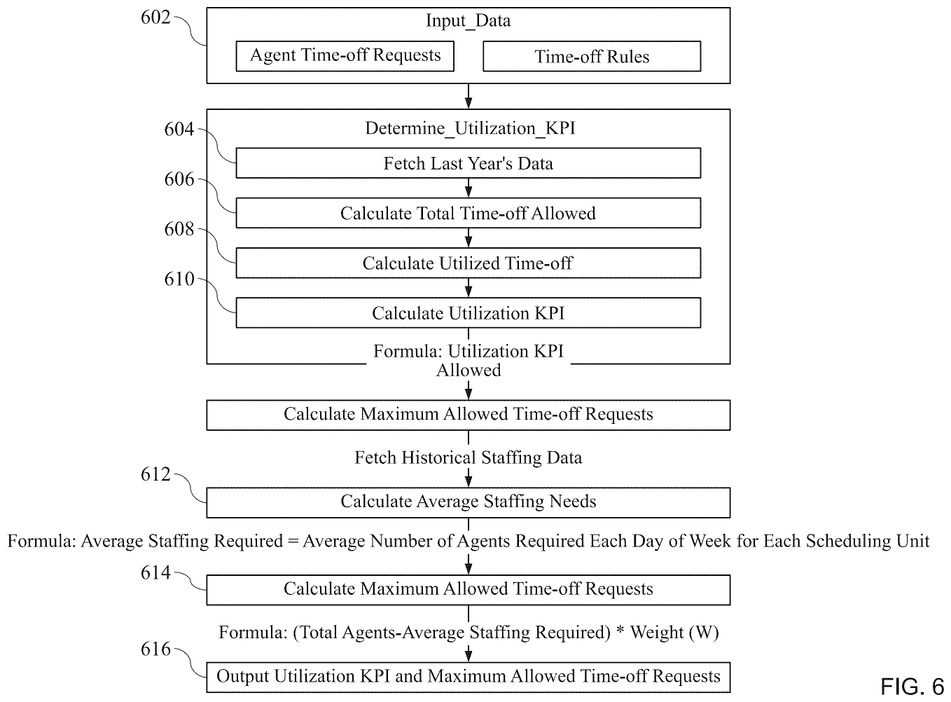

FIG. 6 shows an example process for determining a utilization key performance indicator according to some embodiments of the invention.

Some embodiments may include optimizing a time off rule, the rule comprising a quota of time off units for a time period, wherein the optimizing comprises changing the quota of time off units based on calculating a time off utilization indicator, the calculating of a utilization indicator based on a utilized time off value and the quota of time off units. A nonlimiting example process or algorithm for determining a utilization key performance indicator is provided in Table 3:

### Input Data 602:

```
TABLE 3
  Agent time-off requests: this may include, e.g., historical data of time-off requests for each
  agent and activity code.
  Time-off rules: this may include existing rules defining allowed time-off days for each
  activity code.
Nonlimiting example process:
  Fetch Last Year's Data 604:
    Retrieve the past year's time-off requests for each activity code and agent.
    Data source: historical time-off request database of WFM.
  Calculate total time-off allowed 606:
    For example, for each time-off rule, and using the example formula:
    (eq. 1) Total Time-Off Allowed = Time-Off Days * Number of Agents in
    Scheduling Unit (SU)
  Calculate utilized time-off 608:
    For example, for each time-off rule, and using the example formula:
    (eq. 2) Utilized Time-Off = Sum of Approved Time-Off Days for All Agents
  Calculate utilization KPI 610:
    For example, for each time-off rule, and using the example formula:
    (eq. 3) Utilization KPI = Utilized Time-Off / Total Time-Off Allowed
```

Some embodiments may calculate or compute the maximum or total allowed time off requests, for example, using staffing data or information.

For example, some embodiments may fetch historical staffing data to calculate average staffing needs 612. In one nonlimiting example, based on an example historical staffing data or information SI describing five time period or days, and where SI={5,4,5,5,6}—which may show or designate that 5 agents were staffed for a first historical time period or day, 4 agents were staffed for a second day, and the like—an average staffing need (ASN) may be calculated as, e.g., ASN=(5+4+5+5+6)/5=5 agents per time unit or period.

Some embodiments may calculate maximum or total allowed time off requests, or weight a maximum or total allowed number of requests or time off units 614, for example, using a formula such as, e.g.:

$$TTO = ( N - A SN ) * W \qquad ( eq . 4 )$$

where TTO is the total time off requests or time off allowed, N is the total number of agents or resources included or available in the organizational unit under consideration, ASN is the average staffing requirement, and W is a predefined and/or configurable weight or coefficient. As a nonlimiting example, for a time period or day where there are 6 agents in the SU considered or N=6, and given ASN=5, and W=1.0, TTO may be calculated as TTO=(6−5)*1=1, which may mean that only 1 time off request may be approved, or that only 1 time off unit may be utilized for the relevant day. In some embodiments, a different value may be used for weight W, e.g., 0.5—for example in a case where it is desirable to keep more resources or agents available for emergency needs (e.g., if one agent turns out sick and leaves after working for only half a day).

In some embodiments, the optimizing of the time off rule and the updating of the schedule are performed based on a staffing requirement, the requirement comprising a number of resources needed for the time period. An example algorithm for determining a maximum number of allowed time-off requests or a maximum allowed time off requests value is provided in Table 4:

```
TABLE 4
Fetch Historic Staffing Data:
  Retrieve historical staffing data for each scheduling or organizational unit.
  Data source: staffing database of WFM.
Calculate Average Staffing Needs (which may be used, e.g., as a forecasted staffing
requirement or number of resources needed for a given time period):
  Formula: Average Staffing Required = Average Number of Agents Required Each
  Day of Week for Each Scheduling Unit
Calculate Maximum Allowed Time-Off Requests (e.g., based on the calculated staffing
requirement or the average staffing needed):
  Formula: Maximum Allowed Time-Off Requests = (Total Agents − Average
  Staffing Required) * Weight (W)
  The weight (W) may be configured, e.g., as per business needs to allow flexibility
  and tuning.
```

Some embodiments may output a utilization KPI and/or and maximum allowed time off or time off requests 616, which may be used in additional operations such as for example described herein. Additional or alternative calculations or computations may be used in different embodiments.

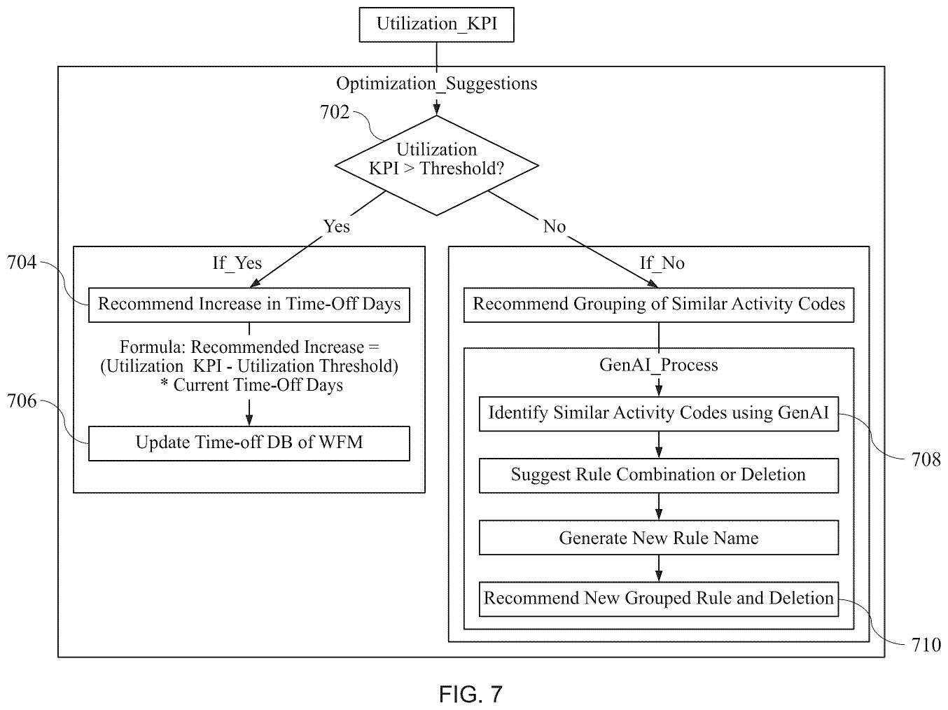

FIG. 7 shows an example generation of an optimization plan according to some embodiments of the invention. Some embodiments may include identifying, by a machine learning model, one or more rules matching the time off rule, the identifying based on activity codes for the rules similar to the time off rule.

A nonlimiting example process for generating a time off optimization plan for time off rules according to some embodiments is provided in Table 5.

```
TABLE 5
Utilization KPI > Threshold? 702:
    If Yes, proceed to recommend an increase in time-off days.
    If No, proceed to recommend grouping similar activity codes.
Processes:
    1. If Utilization KPI > Utilization Threshold:
        Recommend Increase in Time-Off Days 704:
        Formula: Recommended Increase = (Utilization KPI − Utilization Threshold) *
        Current Time-Off Day Quota
    Automate Suggestion:
        a. Remove or delete under-utilized rules (or rules for which a calculated KPI value
    is below a threshold T).
        b. Update the time-off database and/or notify manager device 706.
    2. If Utilization KPI < Utilization Threshold:
    Identify Similar Activity Codes using GenAI 708:
        a. Algorithm: Use GenAI to analyze activity code names to identify rules matching
        a given time off rule, and suggest grouping of time off rules.
        b. Sample Prompt to GenAI: “Group the activities based on similar
        names/codes/identifiers: Activity 1, Activity 2, Activity 3.”
    Combine Rules of Similar Activities:
        c. Based on GenAI output, combine or merge rules with utilization below the
    threshold. In some embodiments, rule merging may be, e.g., a two step process where a
    new rule with a name suggested or generated by the LLM or GenAI may first be created,
    and the original rule data structures for the merged rules which were found similar to each
    other may subsequently be deleted. The new time-off quota or the quota/amount of time
    off or downtime units for the newly created rule may be calculated, for example, based on
    quotas and/or utilization values for the merged rules − and may be or may equal, for
    example, a combined quota or a sum of the quotas for the merged rules, the average value
    for the quota of the merged rules, or the product of the average UTO or utilization KPI for
    the merged rule time the average the average value for the quota of the merged rule − e.g.,
    $according to expressions or formulas such as : \frac{\sum UTO * \sum TTO}{N} , \frac{\sum uKPI * \sum Q}{N} , and the like , where N$
    is the number of merged rules or rules to be merged, uKPI is the utilization KPI, and Q is
    the quota of time off units for a given rule, and where Σ is a sum over the relevant values
    for all N merged rules. Additional or alternative rule merging procedures may be included
    in different embodiments.
        d. Generate a new rule name and update the time-off rule database to delete old
    rules and to include new merged or combined rule 710.
```

Additional or alternative operations or calculations may be included or used in different embodiments.

In some embodiments, the optimizing of the time off rule and the updating of the schedule are performed based on a staffing requirement, the requirement comprising a number of resources needed for the time period. Some of the example processes described with reference to FIGS. 3-7 may be implemented or executed using, e.g., the example algorithm in Table 6:

```
TABLE 6
Step 1: Determine the Utilization KPI for Time-Off Rules
  Retrieve the past year's time-off requests for each activity code and agent.
  For each time-off rule, perform the following calculations:
    Total Time-Off Allowed = Number of time-off days * Number of agents.
  Utilized Time-Off = Sum of approved time-off days for all agents.
  Total Utilization KPI = Utilized time-off / Total time-off allowed.
Step 2: Develop an Optimization Plan for the Rules
  If the Utilization KPI exceeds the utilization threshold:
    Suggest an increase in the number of time-off days by removing under-utilized
    rules.
      Formula for Increasing Days:
      Recommended Increase = (Utilization KPI − Utilization Threshold) *
      Current time-off days.
  If the Utilization KPI is below the utilization threshold:
    Identify similar activity codes using generative AI (GenAI) analysis.
    Example Prompt: ″Group the activities based on similar names/codes/identifiers:
    Activity1, Activity 2, Activity 3.″
    Combine rules for similar activities with utilization below the threshold based on
    GenAI output.
Step 3: Determine the Maximum Allowed Time-Off Requests
  Retrieve historical staffing data (e.g., spanning a predefined time period such as, e.g., 1
year) for the relevant scheduling unit or units.
  Calculate the average number of agents or average staffing value required for each day of
  the week, e.g., for combined or grouped rules, e.g.:
    Average staffing required (for a specific day)
    =(Sum of agents required on that day over a period)/
    (Number of occurrences of that day in the period)
  Calculate a maximum allowed time off request value based on the calculated average
  staffing value, e.g.:
    Maximum Allowed Time-Off Requests = (Total agents − Average staffing
    required) * W, where W may be a weight configured according to business needs.
Step 4: Automate the Optimization of Rules
  Once recommendations are approved (e.g., by a manager's device), update the rules
  accordingly.
```

Additional or alternative operations may be included and used in different embodiments of the invention.

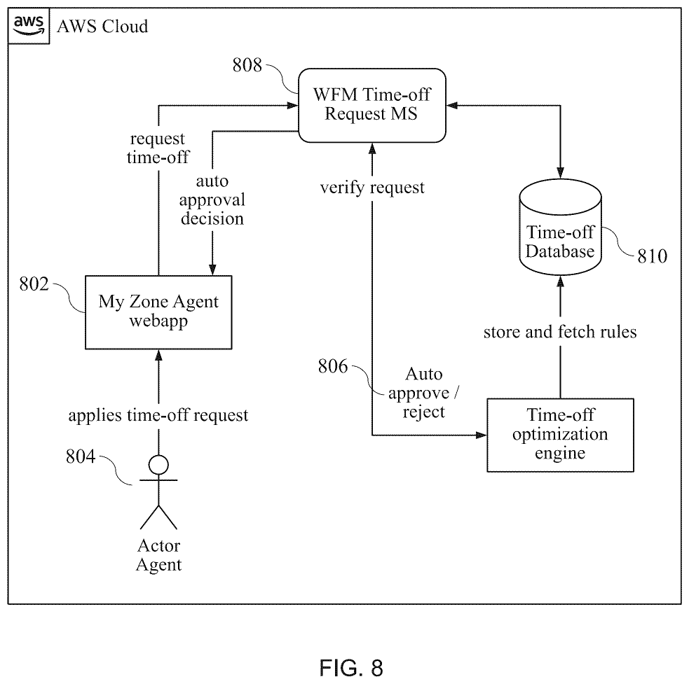

FIG. 8 shows an example time off rule automation and an example use of updated time off rules according to some embodiments of the invention.

Some embodiments may include automatically approving or automatically rejecting a time off request based on the optimized time off rule.

Some embodiments may implement an automation process using, e.g., an agent user interface which may referred to, e.g., as a “My Zone” module or web app 802 which may be used as part of a time off management process, e.g., in addition to a time-off optimization engine performing various operations such as, e.g., described herein. Various components may deployed or implemented, e.g., using the AWS private network with restricted access rules. The time-off optimization engine may use, e.g., input data received from different WFM microservices and components which may be deployed as AWS ECS containers and using AWS RDS services for data storage. An example algorithm for using time off rules according to some embodiments of the invention is provided in Tables 7-8.

TABLE 7
System flow: Some embodiments may receive a time-off request, e.g., by agent 804
requesting time off, and may automatically approve or reject (also referred to as “auto
approve/reject) the request 806 following the optimization of time off rules. Consider the
following, nonlimiting example scenario:
Use case: following optimization of time off rules (which may be performed, e.g., based
on a request or command by a manager/admin), agent 804 may apply or send a time-off
request
Initiation: agent 804 may trigger the time-off request via the My Zone Agent web app 802.
The activity code or name for the time-off request may be selected, for example, by the
agent using a dedicated graphical user interface in My Zone Agent web app 802.
Data retrieval: upon initiation, a time-off request microservice 808 (which may be
implemented, e.g., in a WFM application) may receive the request along with details or
metadata such as, e.g., date and activity code. The received request may be stored in time-
off database 810, which may be, e.g., a cloud based RDS service.
Time-off optimization: optimized rules may be stored in time-off database 810 and may be
fetched or retrieved to determine whether a time off request is to be approved/confirmed
or rejected/denied.
Automation or automated actions: the time off or downtime request may be auto approved,
e.g., based on the automated determination or decision from by a time-off optimization
engine (such as, e.g., described with regard to FIG. 3-7). This decision may be stored in
database 810 and may be displayed to agent 804, for example via My Zone web app 802.
Decisions or automated actions performed using some embodiments of the invention
(including, e.g., updating schedules based on or according to automatically
approved/rejected time off requests) may eliminate the need of manually approving or
rejecting requests, e.g., by a manager or system administrator, which may result in
substantial savings in human resource times, and in lowering or mitigating of human errors.

```
TABLE 8
Automation process, algorithm, and decision:
1. Fetch Agent's time-off request data:
      Retrieve the agent's request from the my zone webapp 802 along with data or
      metadata such as, e.g., like activity code and date/time.
      Data Source: time-off request database.
2. Fetch the optimized time-off or downtime rule:
      A time-off optimization engine may determine a maximum allowed time-off
      request based on or used time off rules.
      Data source: Fetch optimized rule(s) from time-off database.
3. Decision factor for auto-approve/reject:
      Some embodiments may fetch the optimized rule by matching the activity code and
      scheduling unit using nonlimiting example code snippet 1.
      Some embodiments may decide if the request is to be auto-approved or rejected
      using nonlimiting example code snippet 2.
Example code snippet 1:
  public static String findMatchingRule(String activityCode, String schedulingUnit) {
    String rule = null;
    String sql = ″SELECT rule FROM rules WHERE activity_code = ? AND
scheduling_unit = ?″;
      try (Connection conn = DriverManager.getConnection(JDBC_URL,
      JDBC_USER, JDBC_PASSWORD);
            PreparedStatement pstmt = conn.prepareStatement(sql)) {
      pstmt.setString(1, activityCode);
      pstmt.setString(2, schedulingUnit);
      try (ResultSet rs = pstmt.executeQuery( )) {
        if (rs.next( )) {
          rule = rs.getString(″rule″);
        } } }
    return rule; }
Example code snippet Snippet 2:
      if rule.get_maximum_request( ) > request.get_total( ) {
        return “Approve the request”}
      else { return “Reject the request” }
```

Additional or alternative operations may be used in different embodiments of the invention.

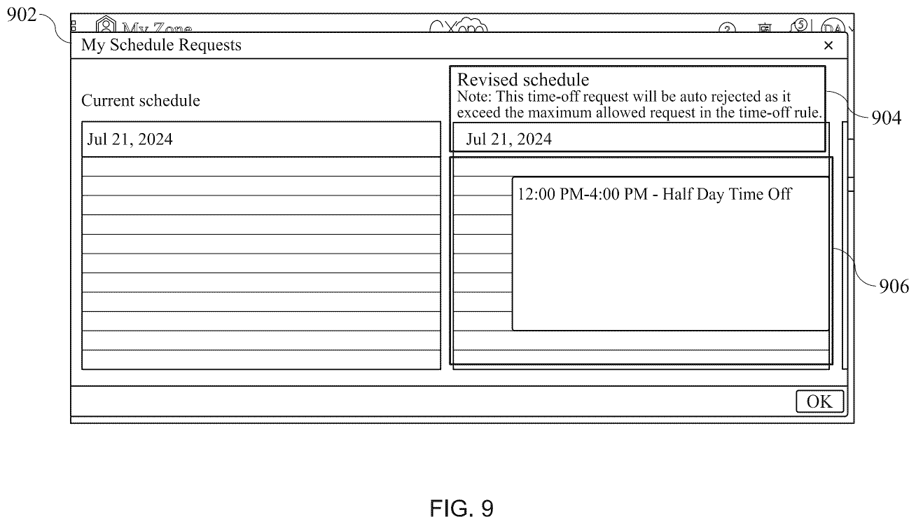

FIG. 9 shows an example user interface (UI) according to some embodiments of the invention.

Some embodiments may include updating a schedule based on the optimized time off rule, wherein the schedule comprises one or more computer tasks to be executed. In some embodiments, the updating of the schedule is performed based on the automatically approved or the automatically rejected time off request.

Some embodiments may display a decision or determination (e.g., to auto approve or reject a time off or downtime request) on a UI—e.g., on an agent device or computer system and/or via time-off web app 802. Depending on an automated determination or decision, some embodiments may automatically determine, mark or label the request as approved or rejected, and may store the marked or labeled request, e.g., in time-off database 810. In some embodiments, when the user is about to submit the request or when the user submits the request, a corresponding message may be displayed on UI 902 as per the decision, which may be made in real time (for example immediately after the user submits the requests or selects an activity code or time off type, such as, e.g., “paid time off”). In the example depicted in FIG. 9, user interface or UI 902 shows a message or notification that the agent's request being auto-rejected 904 by the system. In this specific nonlimiting example scenario, a time-off request may be raised or submitted by the agent, and there may be no room or quota for approving time off request in a current schedule for the agent on the date of Jul. 21, 2024. The agent may apply the request, e.g., for “Half Day Time-Off”, from 12 PM to 4 PM. This may be displayed, e.g., in a schedule window 906 for the agent. However, during this time, and for example due to pre-existing time-off requests using the relevant quota of time off units for the relevant date, the request may be auto-denied or auto-rejected by the system, and a corresponding message 904 may be provided or received upon submitting the time off request. In such a scenario the agent's schedule may not be updated, or may be updated not to include a break or time off as requested by the agent.

In a different scenario where the request may be approved using a time off rule (which may be, e.g., a time off rule optimized according to some of the protocols and/or operations described herein), some embodiments may for example change or update the agent's schedule (such as, e.g., the schedule displayed in element 906) to include or to display a break or time off during the requested time interval (e.g., from 12 PM to 4 PM). During this time interval, no tasks or operation may be scheduled for the agent. Additionally or alternatively, tasks scheduled for the relevant time interval may be rescheduled for a different time interval. In some embodiments of the invention, an agent may request time off by sending, transmitting, or triggering a time off request which may be automatically approved/rejected (see nonlimiting examples herein) or manually approved/rejected (e.g., by a manager or administrator), Following the approval/rejection of a request, the agent's schedule may be updated automatically—for example by the nonlimiting example WFM applications or tools mentioned herein. A nonlimiting example schedule data structure according to some embodiments may include a start time, an end time and an activity code or name for each scheduled activity or entry, such as for example: {[8 AM-10 AM: “on call”], [10 AM-12 AM: “break” ], . . . } and the like (where activity codes of names are provided in quotation marks). Accordingly, if a time-off request for 8 AM-10 AM is approved for or using a “Medical Leave” rule, the corresponding activity code on the schedules for that time period may change from “on call” to “Medical Leave”, and the resulting schedule may be, e.g., {[8 AM-10 AM: “Medical Leave” ], [10 AM-12 AM: “break”], . . . }. Additional or alternative example schedules and schedule updating procedures may be used in different embodiments.

Some embodiments may include executing one or more of the tasks based on the updated schedule.

Some embodiments of the invention may execute computerized tasks or operations (such as handling VoIP interactions using a computer system) based on an updated schedule. In one example, some embodiments may route VoIP interactions (e.g., using an automatic call distributor, ACD, and/or private branch exchange, PBX, components) to a computer device operated by the agent whose time off request was approved based on a schedule updated based on an optimized time off rule based on which a time off request was approved. In such an example, some embodiments may route a VoIP call to a computer device operated by the agent based on the updated schedule—e.g., at the time when time-off ends in the updated schedule. In other examples involving, e.g., managing breaks and shutdowns of hardware systems, some embodiments may schedule and execute, e.g., processing tasks or operations at the time where a break in the updated schedule ends (for example, if a break request was approved and the schedule was updated based on an optimized time off rule to include a break between hours 00:00-01:00 on a given day, some embodiments may schedule and/or execute processing or computing tasks exactly at 01:00). Additional or alternative examples may be realized with reference to different embodiments.

Additional or alternative UI elements and components may be included or used in different embodiments.

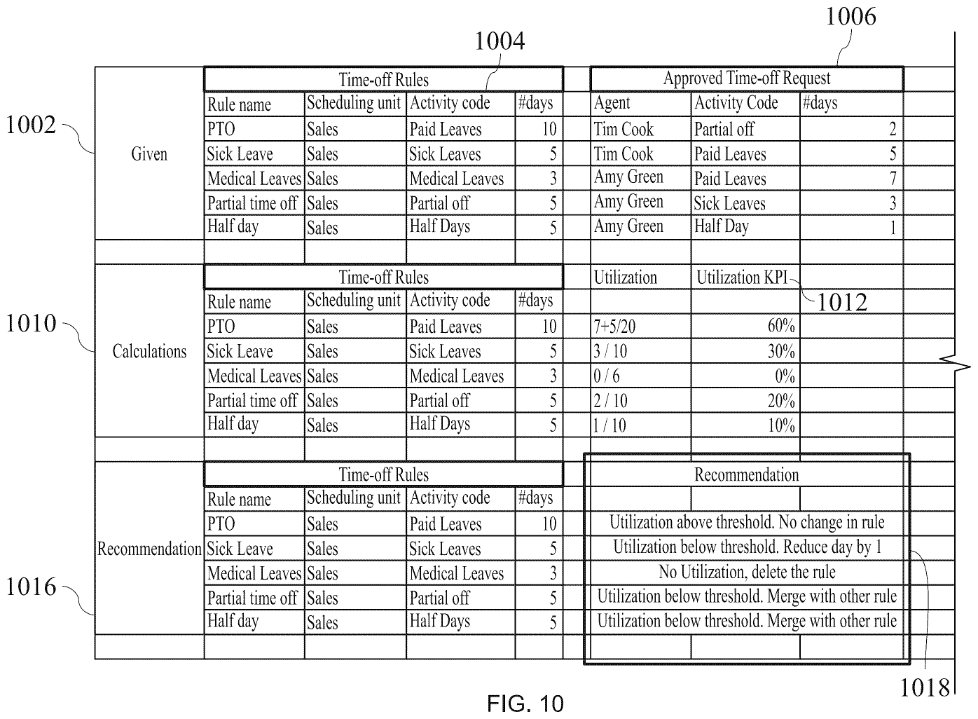

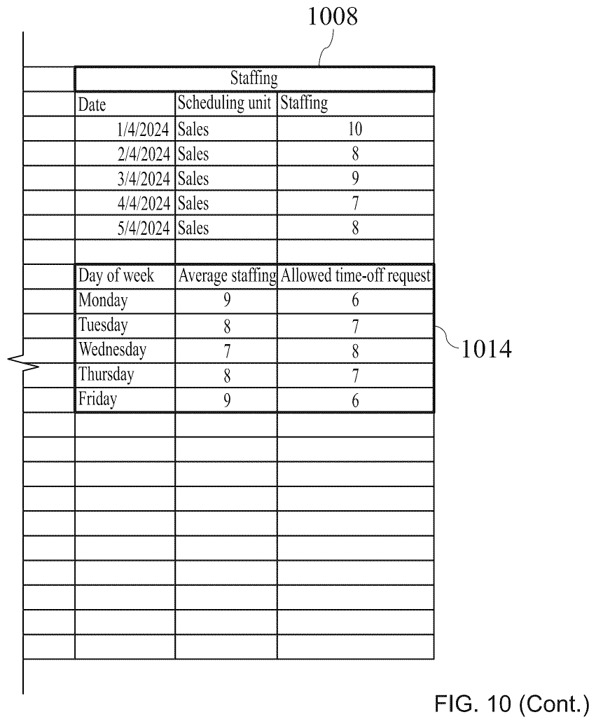

FIG. 10 shows some example data structures which may be used in some embodiments of the invention.

A “given” block 1002 may store or describe the present time off rules stored in the system. For example, there may be 5 time off rules named: “PTO”, “Sick Leave”, “Medical Leaves”, “Partial Time Off” and “Half Day”. for the scheduling unit “Sales”, where each rule may be associated or labeled using a corresponding identifier or activity code 1004 such as, e.g., “Paid Leaves”, “Sick Leaves”, “Medical Leaves”, “Partial Off” and “Half Days”, respectively and number of days or time off units allowed for each rule and/or code, such as, e.g., 10,5,3,5,5 respectively.

A block of “Approved Time-off Request” 1006 may describe approved requests, their associated activity codes or identifiers, and number of time units per request for a plurality of agents. Staffing data 1008 for a given scheduling unit (e.g., “Sales”) is provided for relevant dates.

A calculations block 1010 may describe calculated time-off rule utilization indices or values and a utilization KPI 1012 may be calculated and stored for each rule. Statistics or calculated data 1014 such as, e.g., average staffing values for a given day of the week, calculated values for allowed time-off request or time off requests allowed or approved per given day, and the like—and/or comparisons between different calculated values, may also be provided.

A recommendation block 1016 may include or store a recommendation 1018, e.g., for each relevant rule, for example based on outputs by a GenAI or LLM component, and for example after a manager/admin approves or requests optimization of relevant time off rules.

Additional or alternative data structures and/or formats may be used in different embodiments of the invention.

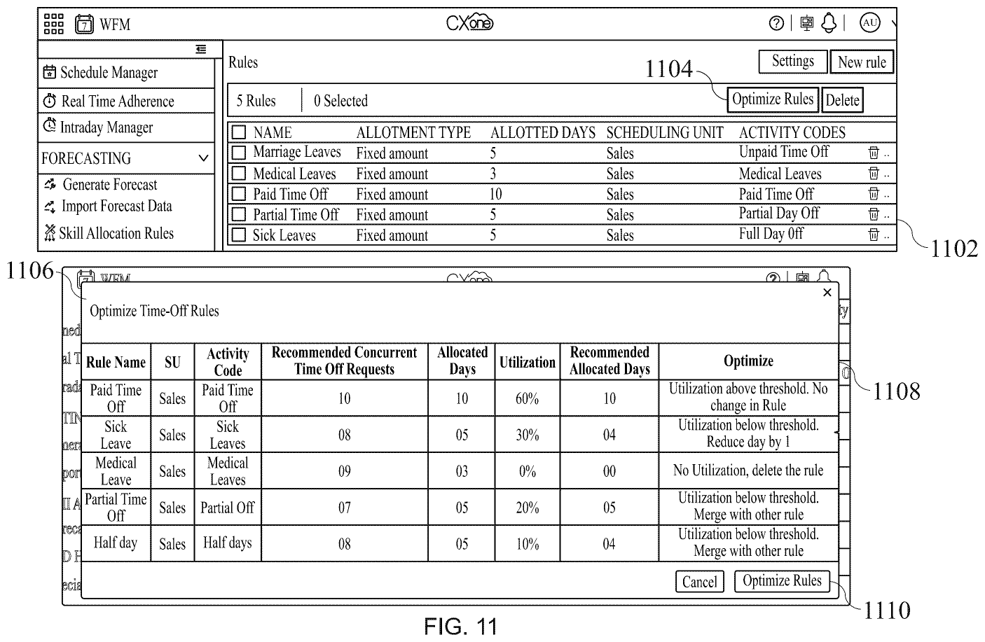

FIG. 11 shows an example time off rule optimization user interface (UI) and an example output by a generative artificial intelligence (GenAI) component according to some embodiments of the invention.

In the nonlimiting example interface depicted in FIG. 11, time off rules may be presented on a rules page 1102 as part of a WFM platform, which can be accessed, e.g., using Login>WFM>Rules (Time Off Rules). Rules page 1102 shows time off rules and their names as present in the system in a given point in time, such as for example “Paid Time Off”, “Sick Leave”, “Medical Leaves”, “Partial Time Off” and “Half Day”, together with “Allowed Days” or “Allotted Days”, or time off units already allocated, allowed or approved, the “Scheduling Unit” for which time off rules may be applied, “Activity Code” or identifier for each relevant rule, and an “Allotment Type” which may be, e.g., a fixed amount or quota of time off units (such as, e.g., 5 days per month). Along with the rules, an “Optimize Rules” button 1104 may be used (e.g., by a manager or system administrator) to trigger or initiate rule optimization, e.g., according to the various operations and procedures described herein.

Element or data structure 1106 shows a nonlimiting example output such as, e.g., a recommendation or recommendations from a GenAI or LLM component to implement on or apply to each time-off rule of a plurality of rules. In some embodiments, GenAI or LLM optimization recommendation may be provided as a table, where each rule—which may be associated with a scheduling unit and an activity code or identifier—may be presented with data such as, e.g., time off unit quota or recommended or allowed number of time off requests that may be submitted concurrently, a number of allocated days, a calculated utilization KPI value, a recommended value for allocated days (e.g., based on historical time off data and/or statistics), and an optimization recommendation or instruction 1108. In one nonlimiting example, for the rule “Paid Time Off” the optimization instruction or recommendation may be “Utilization above threshold hence there no change in the rule is recommended based on utilization KPI”—while for the rule “Sick Leave” an instruction or recommendation may be “Utilization below threshold, reduce time off day quota by 1 day based on Sick Leave's Utilization KPI values”.

Some embodiments may include merging a time off rule with one or more of the identified rules.

For rules having low utilization KPI values, some embodiments may recommend merging a given rule with rules identified as having similar or matching names and/or activity codes. For example, a GenAI or LLM component or module may recommend merging the rule “Partial Time Off” with the rule “Half Day”—for example based on low utilization KPI values (e.g., below a predetermined threshold) calculated for the rules (which may mean that the time off rule is not used in practice to schedule time off for relevant resources or agents, and may thus just amount to clutter within the system and may be prone to cause future time off related scheduling or staffing errors) and based on the LLM or GenAI component determining that “partial time off” may be matching, may be synonymous, or may be used interchangeably, with “half days”.

Some embodiments may include generating, by the machine learning model, a rule name for the optimized time off rule.

In some embodiments, a machine learning model such as, e.g., a GenAI or LLM component of module may provide or generate a name or activity code for merged rules. In this context, some embodiments may generate rule names using a dedicated name creation or generation prompt. For example, an LLM may be used to cluster or group and generate a recommendation to merge the rules “Partial Time Off” and “Half Day”, each having 5 allocated days or a quota of 5 days, into a single rule having a quota of 5 days (e.g., in case utilization KPI values for each of the two rules are below a threshold T), and may be provided a nonlimiting example name generation prompt “Generate a new, clear, and concise rule name that effectively combines the concepts of ‘partial day’ and ‘half day’ time-off activities” to generate the example name “partial day time off” for the new or merged rule. Additional or alternative name generation or creation prompts may be used in different embodiments. New rules and/or updated or optimized rules may be displayed on rules page 1102 following optimization according to some embodiments of the invention.

According to some embodiments, optimizations of rules may be suggested and may be displayed to, e.g., manager or system administrators in a contact center. For instance, if a manager/administrators clicks on optimize rules button 1110, then some embodiments may apply optimization instructions or recommendations by the LLM or GenAI component, and changes to rules may be entered, saved, implemented or automated in the system. A rules database or datastore may be updated following an optimization or automation procedure, and new or updated rules may be applied to new time off requests.

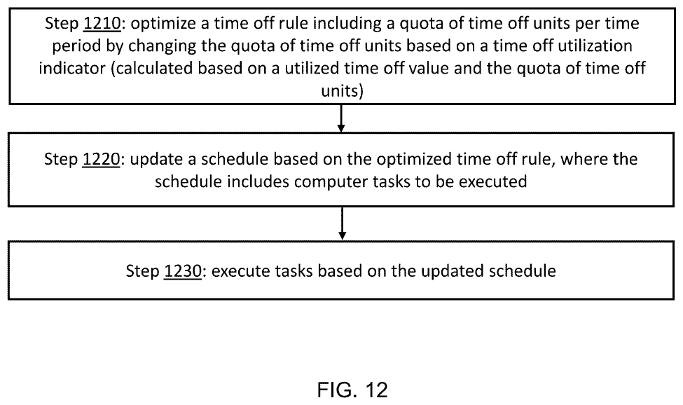

FIG. 12 is a flowchart describing an example method for computerized task scheduling and execution according to some embodiments of the invention.

In operation 1210, some embodiments may optimize a time off rule, where the rule includes a quota of time off units for a time period—by changing the quota of time off units based on calculating a time off utilization indicator, e.g., based on a utilized time off value and the quota of time off units. Some embodiments may update a schedule based on the optimized time off rule, where the schedule includes one or more computer tasks to be executed (operation 1220) and execute one or more of the tasks based on the updated schedule (operation 1230). Additional or alternative operations may be used in different embodiments.

Some embodiments of the invention may improve the technology of managing and scheduling computer actions and resources, and time off management technologies, by providing a dynamic and data-driven approach for automatically calculating, determining, or updating quotas of time off units, and by automatically removing cluttered or unused rules from the system (e.g., by merging them with other rules). While previous systems and methods focus on compliance with organizational policies, they often rely on static rules and manual adjustments to quotas and parameters without leveraging real-time data and advanced analytics. In contrast, some embodiments of the invention may automatically update rules and quotas, e.g., based on a utilization KPI and instructions/recommendations by an LLM that may be generated and implemented/used in real time and, e.g., based on real-time staffing patterns and requirements, which may ensure that a resource pool or workforce remains balanced and efficient in handling relevant tasks. By integrating advanced methodologies, some embodiments may provide a responsive and efficient system and technology solutions that may adapt to changing time off usage patterns and/or staffing needs.

Some specific example technology improvements provided by some embodiments may include, e.g.:
Convenient and simple time-off rule management: some embodiments may significantly reduce the administrative burden on managers by streamlining the process of managing time-off rules. With automated rule generation and optimization based on utilization KPIs, managers may focus on more strategic tasks rather than spending time on manual adjustments to time off rules and quotas.
Automated rule generation: some embodiments may automatically generate, optimize, or update time-off rules using historical data and compliance requirements (e.g., once in a predetermined time period, such as for example at the beginning of a given year). This automation may ensure that the rules and quotas are up-to-date, compliant, and tailored to usage and staffing patterns, needs and requirements, reducing the need for manual intervention.
Enhanced agent experience: by limiting the number of time-off rules and basing approvals for time off requests on a robust set of criteria, some embodiments may make it easier for agents to request and receive time-off when needed. This transparency and efficiency in the approval process may improve overall agent satisfaction and engagement.
User-friendly WFM time-off management module: a workforce management (WFM) time-off management module according to some embodiments may be designed to be seamlessly integrated into existing systems, and be intuitive and user-friendly. Managers and agents alike may easily navigate the system, making it simpler to handle time-off requests and approvals.
Clear visibility of time-off utilization: some embodiments may calculate and clearly display the utilization of time-off quotas and/or rules, providing managers with valuable insights into how these rules are being used in practice. Visibility may help in making informed decisions about adjustments and optimizations, ensuring that time-off policies remain effective.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A computerized method for computerized task scheduling and execution, comprising, using one or more computer processors:
optimizing a time off rule, the rule comprising a quota of time off units for a time period, wherein the optimizing comprises changing the quota of time off units based on calculating a time off utilization indicator, the calculating of the time off utilization indicator based on a utilized time off value and the quota of time off units;
updating a schedule based on the optimized time off rule, wherein the schedule comprises one or more computer tasks to be executed; and
executing one or more of the tasks based on the updated schedule.

2. The method of claim 1, wherein optimizing of the time off rule comprises:
identifying, by a machine learning model, one or more rules matching the time off rule, the identifying based on activity codes for the rules similar to the time off rule; and
performing one or more of: deleting one or more of the identified rules, and merging the time off rule with one or more of the identified rules.

3. The method of claim 2, comprising generating, by the machine learning model, a rule name for the optimized time off rule.

4. The method of claim 1, wherein the optimizing of the time off rule and the updating of the schedule are performed based on a staffing requirement, the requirement comprising a number of resources needed for the time period.

5. The method of claim 1, comprising automatically approving or automatically rejecting a time off request based on the optimized time off rule, wherein the updating of the schedule is performed based on the automatically approved or the automatically rejected time off request.

6. The method of claim 2, wherein the identifying of the one or more rules matching the time off rule comprises clustering, by the machine learning model, one or more of the rules into one or more clusters, wherein the one or more rules matching the time off rule are included in one of the clusters including the time off rule.

7. The method of claim 4, wherein the optimizing of the time off rule and the updating of the schedule are performed using a cloud platform, and wherein the optimizing of the time off rule comprises fetching staffing data from a cloud based database.

8. A computerized system for intelligent computerized task scheduling and execution, comprising:
a memory; and
one or more processors configured to:
optimize a time off rule, the rule comprising a quota of time off units for a time period, wherein the optimizing comprises changing the quota of time off units based on calculating a time off utilization indicator, the calculating of a utilization indicator based on a utilized time off value and the quota of time off units;
update a schedule based on the optimized time off rule, wherein the schedule comprises one or more computer tasks to be executed; and
execute one or more of the tasks based on the updated schedule.

9. The system of claim 8, wherein the optimizing of the time off rule comprises:
identifying, by a machine learning model, one or more rules matching the time off rule, the identifying based on activity codes for the rules similar to the time off rule; and
performing one or more of: deleting one or more of the identified rules, and merging the time off rule with one or more of the identified rules.

10. The system of claim 9, wherein one or more of the processors are to generate, by the machine learning model, a rule name for the optimized time off rule.

11. The system of claim 8, wherein the optimizing of the time off rule and the updating of the schedule are performed based on a staffing requirement, the requirement comprising a number of resources needed for the time period.

12. The system of claim 8, wherein one or more of the processors are to automatically approve or automatically reject a time off request based on the optimized time off rule, and wherein the updating of the schedule is performed based on the automatically approved or the automatically rejected time off request.

13. The system of claim 9, wherein the identifying of the one or more rules matching the time off rule comprises clustering, by the machine learning model, one or more of the rules into one or more clusters, wherein the one or more rules matching the time off rule are included in one of the clusters including the time off rule.

14. The system of claim 11, wherein the optimizing of the time off rule and the updating of the schedule are performed using a cloud platform, and wherein the optimizing of the time off rule comprises fetching staffing data from a cloud based database.

15. A computerized method for intelligent computerized time off management, comprising, using one or more computer processors:
optimizing a downtime rule, the rule comprising an amount of downtime units for a time period, wherein the optimizing comprises changing the amount of downtime units based on computing a downtime utilization score, the computing of a utilization score based on a utilized downtime value and the amount of downtime units;
updating a schedule based on the optimized downtime rule, wherein the schedule comprises one or more computer operations to be executed; and
executing one or more of the computer operations based on the updated schedule.

16. The method of claim 15, wherein the optimizing of the downtime rule comprises:
identifying, by a large language model (LLM), one or more rules matching the downtime rule, the identifying based on identifiers for the rules similar for the downtime rule; and
performing one or more of: deleting one or more of the identified rules, and merging the downtime rule with one or more of the identified rules.

17. The method of claim 16, comprising generating, by the LLM, a rule name for the optimized downtime rule.

18. The method of claim 15, wherein the optimizing of the downtime rule and the updating of the schedule are performed based on a staffing requirement, the requirement comprising a number of resources needed for the time period.

19. The method of claim 15, comprising automatically approving or automatically rejecting a downtime request based on the optimized downtime rule, wherein the updating of the schedule is performed based on the automatically approved or the automatically rejected downtime request.

20. The method of claim 16, wherein the identifying of the one or more rules matching the downtime rule comprises grouping, by the LLM, one or more of the rules into one or more groups, wherein the one or more rules matching the downtime rule are included in one of the groups including the downtime rule.
